(19) United States
(12) Patent Application Publication
(10) Pub. No.: US 2003/0037213 A1
(43) Pub. Date: Feb. 20, 2003

(54) Method for protecting a microcomputer system against manipulation of its program

(76) Inventors: Andreas Mittag, Markgroeningen (DE); Rainer Frank, Sachsenheim (DE)

Correspondence Address: KENYON & KENYON, ONE BROADWAY, NEW YORK, NY, 10004, US

(21) Appl. No.: 10/188,176

(22) Filed: Jul. 1, 2002

(30) Foreign Application Priority Data
Jul. 2, 2001 (DE) 101 31 576.7

(51) Int. Cl. G06F 12/14

(52) U.S. Cl. 711/163; 711/103

(57) ABSTRACT

A method for protecting a microcomputer system against manipulation of its program, the microcomputer system including a rewritable memory in which at least part of the program is stored. A code word is generated on the basis of a start value, using at least part of the contents of the rewritable memory. For enhanced protection of the program against manipulation or tuning, the start value for generating the code word is preselected on a microcomputer-specific basis. The start value is also preselected as a function of the type of microcomputer system. The generated code word is checked in the microcomputer system, and execution of the program of the microcomputer system stored in the rewritable memory is blocked if the code word does not match a preselectable reference code word.

### FIELD OF THE INVENTION

The present invention relates to a method of protecting a microcomputer system against manipulation of its program. The microcomputer includes a rewritable memory in which at least part of the program is stored. According to the method, a code word is formed on the basis of a start value, using at least part of the contents of the rewritable memory.

The present invention also relates to a microcomputer system that is protected against manipulation of its program, including a read-only memory and a rewritable memory in which at least part of the program is stored. For the purpose of protecting the microcomputer system, a code word is formed on the basis of a start value, using at least part of the rewritable memory.

### BACKGROUND INFORMATION

A method and a microcomputer of protecting a microcomputer system against manipulation of its program is referred to in German Published Patent Application No. 197 23 332. The method discussed in this publication is used, in particular, to protect a motor vehicle control unit against manipulation of its control program. The control unit is used to control and/or regulate motor vehicle functions, for example those of an internal combustion engine, an electronic steering system (steer-by-wire) or an electronic brake (brake-by-wire). According to the method referred to in German Published Patent Application No. 197 23 332, a boot routine and, as part of the boot routine, a checking program are executed each time the microcomputer system starts. The checking program is stored in a read-only memory of the microcomputer system. During execution of the checking program, a code word is determined from at least part of the contents of the rewritable memory, using an encryption algorithm, and compared to a reference code word stored in the rewritable memory. The code word is, for example, a checksum. If the determined code word does not match the reference code word, execution of the control program stored in the rewritable memory of the control unit is blocked.

If a manipulated program was stored in the rewritable memory, the code word determined via the memory contents of the rewritable memory typically differs from the stored reference code word. Execution of the manipulated program is blocked. This prevents damage to the motor vehicle functions or motor vehicle units to be controlled or regulated by the control unit due to manipulation of the control program.

U.S. laws governing OBD II (On-Board Diagnostic Ver. II) require control units for internal combustion engines in motor vehicles to run a self-diagnosis. This legislation sets certain exhaust emission limits and requires proof that no manipulation influencing the exhaust emission values of a motor vehicle has been performed on any part of a control unit. To furnish this proof, it is stipulated that a checksum be output via a diagnostic interface of the control unit. The motor vehicle type and checksum of the corresponding control unit are published in tables that are accessible to anyone. Manipulation of the control program typically results in a modified checksum which differs from the checksum stored in the table. Hence, a manipulation of parts of the control unit relating to exhaust emissions may be proven.

One problem with the method referred to in German Published Patent Application No. 197 23 332, however, is that the encryption algorithms for calculating the code word may be known and accessible to the public, or they may be relatively easy to determine. Because the algorithms may be known and accessible to the public, code word generation for the purpose of protecting the program of a microcomputer against manipulation and/or tuning is less effective. In addition, the encryption algorithms referred to in other prior systems all begin with the same start value. The CRC 16 (Cyclic Redundancy Check, 16-bit) encryption algorithm always uses FFFFₕₑₓ as the start value. The CRC 32 encryption algorithm always uses FFFFFFFFₕₑₓ as the start value.

### SUMMARY OF THE INVENTION

It is an object of the exemplary embodiment and/or exemplary method of the present invention to increase the effectiveness of code word generation as a manner of protecting a program of a microcomputer system against manipulation or tuning.

To achieve this object, the present invention describes that, based on the method of the type mentioned in the preamble, the start value for generating the code word be preselected on a microcomputer-specific basis.

The start value for generating the code word is individually preselectable for each microcomputer. However, a common start value for certain microcomputer groups may be preselected. The start value is kept secret so that, to manipulate the program stored in the rewritable memory, third parties would have to know not only the encryption algorithm for generating the code word but also the start value to be sure that a code word check would not detect the manipulated program. The code word is, for example, a checksum. The feature according to the present invention significantly increases the effectiveness of code word generation as protection against manipulation or tuning.

According to an exemplary embodiment of the present invention, the start value for generating the code word is preselected as a function of the type of microcomputer system. According to this exemplary embodiment, therefore, microcomputer systems of the same type form a microcomputer group to which the same start value for generating the code word is assigned.

According to an exemplary embodiment of the present invention, the code word is output via a diagnostic interface of the microcomputer system. The output code word is compared to a reference code word, stored in a publicly accessible table, for the corresponding microcomputer system or the corresponding type of microcomputer system. If the output code word and the reference code word do not match, it may be assumed that the program of the microcomputer system was manipulated.

According to another exemplary embodiment of the present invention, the code word is checked in the microcomputer system, and execution of the microcomputer system program stored in the rewritable memory be blocked if the generated code word does not match a preselected reference code word. According to this exemplary embodiment, therefore, the generated code word is compared within the microcomputer to a preselected reference code word and, if the two code words do not match, further execution of the program stored in the rewritable memory of the microcomputer system is blocked.

The exemplary embodiment of the present invention uses the exemplary method according to the present invention for protecting a motor vehicle control unit against manipulation of its control program, in which the control unit is used to control and/or regulate a motor vehicle function.

A microcomputer-specific start value for generating the code word may be stored in the read-only memory. The start value may not be output from the read-only memory from outside the microcomputer system, nor may the start value be overwritten.

According to an exemplary embodiment of the present invention, the microcomputer system runs a boot routine each time it starts, and the code word generation and a comparison of the generated code word to a preselected reference code word form part of the boot routine. This exemplary embodiment may allow for high manipulation or tuning security using the code word generation operation.

The code word generation and a comparison between the generated code word and the reference code word may be executed only the first time the microcomputer starts. A preselectable identifier may be stored in a memory of the microcomputer system if the generated code word either does or does not match the reference code word. Each subsequent time the microcomputer system starts, all that is needed is to check the stored identifier, and program execution either continues or is blocked.

According to an exemplary embodiment of the present invention, execution of the program of the microcomputer system stored in the rewritable memory is blocked if a generated code word does not match a preselected reference code word.

The rewritable memory of the microcomputer system is configured as an EPROM (Erasable Programmable Read-Only Memory) or as an EEPROM (Electronically Erasable Programmable Read-Only Memory), in particular as a flash memory. The read-only memory may be configured as a selected area in the flash memory.

### BRIEF DESCRIPTION OF THE DRAWINGS

FIG. 1 shows a microcomputer system according to an exemplary embodiment of the present invention.

FIG. 2 shows a flow chart of an exemplary method according to the present invention.

FIG. 3 shows a table to clarify the effect of different start values on the checksum.

### DETAILED DESCRIPTION

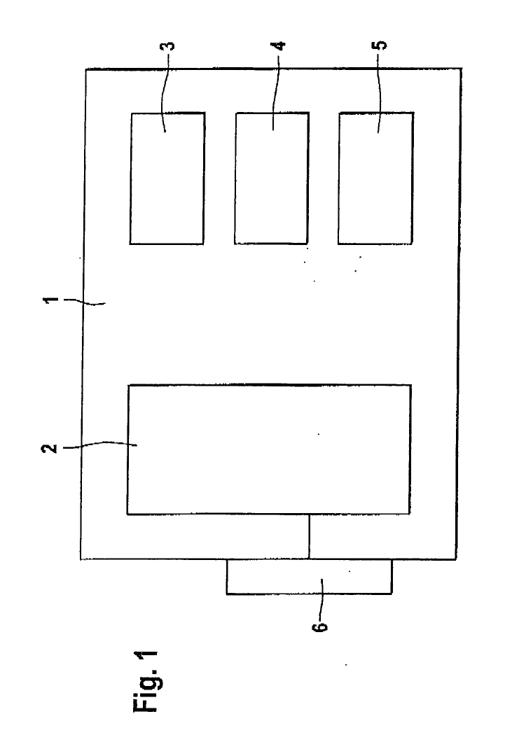

FIG. 1 shows a microcomputer system 1 which includes a central processing unit 2 (CPU) and multiple memories 3, 4, 5. Memory 3 is a read-only memory (ROM), memory 4 a read/write memory (random access memory, RAM) and memory 5 a rewritable memory (Erasable Programmable Read-Only memory, EPROM; Electronically Erasable Programmable Read-Only Memory, EEPROM; or flash EPROM). Program commands or data that are processed by central processing unit 2 are stored in memories 3, 4, 5. Different data or programs are stored, depending on the type of memory 3, 4, 5.

Read-only memory 3 contains a permanently stored program that is modifiable only by producing a new memory chip. A basic program which enables central processing unit 2 to process commands stored in other storage media, in particular rewritable memory 5, is therefore ordinarily stored in read-only memory 3. Read/write memory 4 is able to store data only while microcomputer system 1 is in operation and therefore is only used to store data or program commands while microcomputer system 1 is in operation. The contents of read/write memory 4 may be accessed especially quickly, this may allow for, in part, transfer of programs from other storage media such as read-only memory 3 or rewritable memory 5 to read/write memory 4 and execution of them from there. Rewritable memory 5, which in the present exemplary embodiment is configured as an EPROM or a flash EPROM, contains program segments or data that are to be modifiable to a certain extent. Microcomputer system 1 may be adapted to different tasks. This may be useful when using microcomputer system 1 as a control unit for a motor vehicle. In this case not only the basic program but also control programs for the internal combustion engine or other motor vehicle functions are stored in read-only memory 3. Data, such as parameters or limit values for operating the internal combustion engine, which are accessed by the control program, are then stored in rewritable memory 5.

Additional program modules, which, for example, are not implemented for every control unit, are also storable in rewritable memory 5. Thus, one control unit may be used for different applications. The control functions that are identical for all applications are stored in read-only memory 3, while the programs or data that vary among the individual applications are stored in rewritable memory 5.

The problem with this arrangement, however, is that this enhanced flexibility involves the risk of unauthorized persons accessing the contents of rewritable memory 5. When used in motor vehicles, for example, the performance of the internal combustion engine may be increased in this manner by replacing programs or data in rewritable memory 5. However, this performance increase may cause an overload of the internal combustion engine and ultimately even result in a defect in the internal combustion engine, due to manipulation of the control program. To prevent such undesired manipulation of the contents of rewritable memory 5, a checking program is provided in read-only memory 3 which is able to check the contents of memory 5 for such unauthorized modifications.

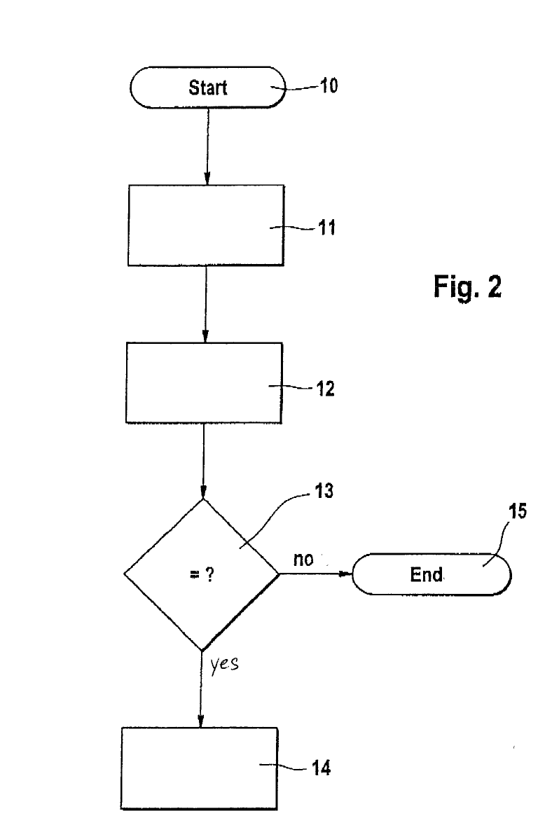

FIG. 2 shows a flow chart of an exemplary method according to the present invention. The method begins in a function block 10. Measures for preparing central processing unit 2 for processing programs are performed in a function block 11. For this purpose, internal registers of central processing unit 2 are set to initial values (known as default values), enabling central processing unit 2 to perform input and output operations needed to process commands.

Following execution of a basic program, i.e., a boot routine, of this type, a code word is determined from at least part of the data contained in rewritable memory 5. A simple example of a code word of this type is a checksum. Based on a checksum, a statement about the status of the data stored in memory 5 may be made. A checksum is determined by performing mathematical calculations (known as encryption algorithms) on at least part of the data stored in memory 5. The result of these calculations is known as a checksum.

A code word may be determined using more or less complex mathematical encryption methods which do not allow an unauthorized person to determine the code word from the contents of rewritable memory 5 without knowing the exact encryption algorithm. In a query block 13, the code word determined in this manner is then compared to a reference code word which is stored, for example, in rewritable memory 5. If the code word and the reference code word match, the remaining program, represented in this case by a function block 14, continues. If the code word and the reference code word do not match, microcomputer system 1 is disabled for further operation. The method is terminated in a function block 15.

An authorized user who would like to modify the contents of rewritable memory 5 thus uses the encryption algorithm, which is known only to him, to determine a reference code from the program stored in memory 5 and then store it in memory 5. After execution of the checking program, microcomputer system 1 will then operate normally. Unauthorized modification of the contents of rewritable memory 5 fails due to the fact that the encryption algorithm is unknown, making it impossible to store a correct reference code word in rewritable memory 5. The checking program determines that the code word and reference code word do not match and disables microcomputer system 1 for processing further tasks. Undesired manipulation of the contents of rewritable memory 5 is thus reliably detected, and operation of the microcomputer system using a manipulated program is suppressed.

Protection of microcomputer system 1 against manipulation of its program may be made significantly more effective, according to the present invention, by preselecting the start value for generating the code word on a microcomputer-specific basis. This means that generation of the code word does not generally begin with the same start value, but rather a different start value is preselectable for different microcomputer systems. Other prior systems assume an initial value or default value as the start value for generating the code word. For example, FFFFₕₑₓ is used as the default value in the CRC 16 (Cyclical Redundancy Check, 16-bit) encryption algorithm, and FFFFFFFFₕₑₓ in the CRC 32 encryption algorithm. According to the present invention, an authorized user who would like to modify rewritable memory 5 must therefore know not only the encryption algorithm but also the start value of the corresponding microcomputer system to be able to determine a valid reference code word and store it in memory 5. The present invention thereby makes the protection against manipulation or tuning significantly more effective.

The start value is variable from microcomputer system 1 to microcomputer system 1. However, it is also conceivable to preselect the same start value for a group of multiple microcomputers, i.e., to predefine the start value as a function of the type of microcomputer system. The code word may be output via diagnostic interface 6 of the microcomputer system.

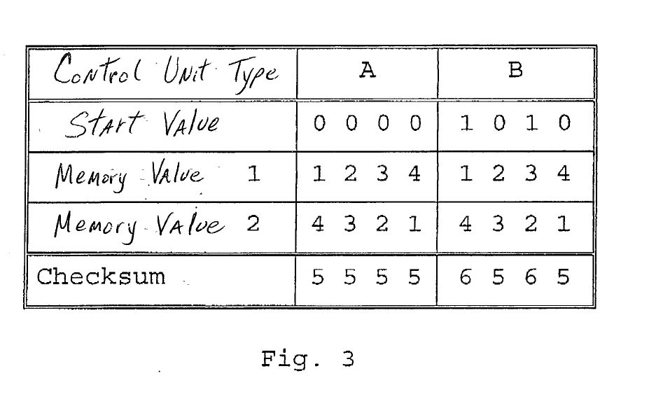

The exemplary method according to the present invention is described on the basis of the table in FIG. 3. This table shows how different start values 0000 and 1010 yield different checksums 5555 and 6565 for two different control unit types A and B despite the fact that the contents of rewritable memory 5, namely memory value 1 and memory value 2, are the same. The method shown in FIG. 3 uses an especially simple encryption algorithm that involves adding memory value 1 and memory value 2 to form a start value. In practice, much more complex encryption algorithms may be used to provide effective protection against manipulation or tuning.

The checking program may be configured to check only individual areas of rewritable memory 5. Also, the checking program may be configured to use different encryption algorithms for different areas of rewritable memory 5 and to store a separate code word for each of these areas. This may allow for either disablement or enablement of individual areas of rewritable memory 5 for reprogramming.

Instead of completely disabling microcomputer system 1, microcomputer system 1 may only be partially disabled when the code word differs from the reference code word. For example, if microcomputer system 1 is used as a control unit for controlling or regulating an internal combustion engine, in the event of unauthorized manipulation of the characteristic map for the ignition angle, an ignition angle may be used that may allow the internal combustion engine to operate at reduced performance, rather than to disable the function, and to trigger a prompt to take the vehicle to the shop for repair. This may allow for continued functioning of microcomputer system 1 at a certain minimum level even when the contents of rewritable memory 5 have been changed accidentally.

The checking program may initially be left in an inactive state and thus initially enable changes to be made to the contents of rewritable memory 5. This may be useful, in particular, during a development phase when modifications still frequently need to be made to the program stored in rewritable memory 5 (application equipment). At the end of development, the checking program is activated, ensuring that further manipulation may be made only with knowledge of the encryption algorithm and the start value (series equipment).

What is claimed is:

1. A method of protecting against manipulation of a program of a microcomputer system, the microcomputer system including a rewritable memory that stores at least part of the program, the method comprising:
preselecting a start value on a microcomputer-specific basis;
generating a code word based on the start value; and
using at least part of a contents of the rewritable memory.

2. The method of claim 1, wherein the start value is preselected as a function of a type of microcomputer system.

3. The method of claim 1, further comprising:
outputting the code word via a diagnostic interface of the microcomputer system.

4. The method of claim 1, further comprising:
checking the code word in the microcomputer system; and
blocking execution of the program if the code word does not match a preselected reference code word.

5. The method of claim 1, wherein the microcomputer system is a motor vehicle control unit and the program includes a control program, and the motor vehicle control unit is configured for controlling a motor vehicle function.

6. A microcomputer system that is protected against manipulation of a program of the microcomputer system, comprising:
a read-only memory to store a microcomputer-specific start value;
a rewritable memory to store at least part of the program; and
a generating arrangement to generate a code word based on the microcomputer-specific start value and to use at least part of the rewritable memory for protecting the microcomputer system.

7. The microcomputer system of claim 6, wherein the microcomputer system executes a boot routine each time it starts, a code word generation operation and a comparison between the code word and a preselected reference code word are part of the boot routine.

8. The microcomputer system of claim 6, wherein execution of the program is blocked if the code word does not match a preselected reference code word.

9. The microcomputer system of claim 6, wherein the rewritable memory is a flash memory.

10. The microcomputer system of claim 6, wherein the read-only memory is a selected area in a flash memory.
